(19) United States
(12) Patent Application Publication
(10) Pub. No.: US 2013/0151628 A1
(43) Pub. Date: Jun. 13, 2013

(54) Time Based System for Urgent Email Messages

(71) Applicants: Pasquale A. Catalano, Newburgh, NY (US); Casimer M. DeCusatis, Poughkeepsie, NY (US); Rajaram B. Krishnamurthy, Wappingers Falls, NY (US); Brian Neugebauer, Hyde Park, NY (US); Michael Onghena, Poughquag, NY (US); Anuradha Rao, Hopewell Junction, NY (US)

(72) Inventors: Pasquale A. Catalano, Newburgh, NY (US); Casimer M. DeCusatis, Poughkeepsie, NY (US); Rajaram B. Krishnamurthy, Wappingers Falls, NY (US); Brian Neugebauer, Hyde Park, NY (US); Michael Onghena, Poughquag, NY (US); Anuradha Rao, Hopewell Junction, NY (US)

(73) Assignee: INTERNATIONAL BUSINESS MACHINES CORPORATION, Armonk, NY (US)

(21) Appl. No.: 13/313,446

(22) Filed: Dec. 7, 2011

(51) Int. Cl. G06F 15/16

(52) U.S. Cl. 709/206

(57) ABSTRACT

An email client receives an urgent tagged email sent by said sender. An urgent timestamp is obtained based on a stored timestamp of a previous urgent tagged email by said sender. Based on the urgent timestamp, it is determined whether said urgent tagged email is allowed. The allowed determining comprises determining whether the urgent tagged email was received within a defined time interval and determining whether the previous timestamp is an allowed value. If the urgent tagged email is allowed, the urgent tagged email is displayed in the email client with an urgent response; a user evaluates whether the urgent tagged email was worth being tagged as urgent; if the urgent tagged email is not worth being tagged urgent, the stored timestamp is updated to the urgent tagged email date; and if the urgent tagged email is worth being tagged urgent, the stored timestamp is updated to the allowed value.

### BACKGROUND

The present invention relates, in general, to emails, and in particular, to urgent emails.

In the current environment, emails are often sent and received at a very frequent rate. Too many emails often prevent the user from being able to read through them all. Even with the current mail systems that allow emails to be marked or tagged as urgent, users often are overwhelmed with the amount of tagged emails that are received.

### BRIEF SUMMARY

According to one embodiment of the present invention, a method, system, and program product is provided for receiving an urgent email message by a sender. An email client on a computer receives an urgent tagged email sent by the sender. An urgent timestamp is obtained based on a stored timestamp of a previous urgent tagged email by the sender. Based on the urgent timestamp, it is determined whether the urgent tagged email is allowed. The allowed determining comprises determining whether the urgent tagged email was received within a defined time interval and determining whether the previous timestamp is an allowed value. Responsive to the urgent tagged email being allowed: displaying the urgent tagged email in the email client with an urgent response; evaluating, by a user, whether the urgent tagged email was worth being tagged as urgent; responsive to the evaluating that the urgent tagged email was not worth being tagged as urgent, updating the stored timestamp to a date of the urgent tagged email; and responsive to the evaluating that the urgent tagged email was worth being tagged as urgent, updating the stored timestamp to the allowed value.

According to one embodiment of the present invention, obtaining an urgent timestamp further comprises determining whether the sender sent a previous extraordinary tagged email to the email client.

According to one embodiment of the present invention, responsive to the determination that the sender did not send a previous extraordinary tagged email, the obtained timestamp is defined to be the allowed value.

According to one embodiment of the present invention, responsive to the urgent tagged email being allowed and responsive to the evaluating that the urgent tagged email was not worth being tagged as urgent, the sender is notified that the user has evaluated the urgent tagged email as not worth being tagged as urgent.

According to one embodiment of the present invention, responsive to the urgent tagged email not being allowed, the urgent tagged email is displayed as a regular untagged email in the email client.

According to one embodiment of the present invention, the urgent response comprises forced opening of the urgent tagged email by the email client, bypassing of spam filtering by the email client, disabling an ability to delete the urgent tagged email until the urgent tagged email is read, full screen takeover of the computer until content of the urgent tagged email is read by user, full screen takeover of the email client until content of the urgent tagged email is read by the user, or a combination thereof.

According to one embodiment of the present invention, the sender is verified against a whitelist. The whitelist is created by the user to designate one or more specific senders who are permitted to send urgent tagged emails to the email client. Obtaining the urgent timestamp is performed in response to the verification that the sender is in the whitelist. Responsive to the verification that the sender is not in the whitelist, the urgent tagged email is displayed as a regular untagged email in the email client. The determination whether the urgent tagged email is allowed, is based on the verification that the sender is in the whitelist.

According to one embodiment of the present invention, the sender writing, on the sender's email client on the sender's computer, the urgent tagged email. The sender, on sender's email client, selects an urgent tag for the urgent tagged email. The sender sends the urgent tagged email.

According to one embodiment of the present invention, the email client supports receiving signed messages.

According to one embodiment of the present invention, the predetermined time value is selected by the user.

### BRIEF DESCRIPTION OF THE SEVERAL VIEWS OF THE DRAWINGS

FIG. 1 illustrates one embodiment of a user interface in accordance with one or more aspects of the present invention.

FIG. 2 illustrates one embodiment of a flow diagram in accordance with one or more aspects of an embodiment of the present invention.

FIG. 3 illustrates one embodiment of a computer program product to incorporate one or more aspects of an embodiment of the present invention; and

FIG. 4 illustrates one embodiment of a computer system in which an embodiment of the present invention may be practiced.

### DETAILED DESCRIPTION

In accordance with one or more aspects of the present invention, a method, system, and computer program product is provided for handling urgent emails. One or more aspects of the present invention may be implemented in a variety of ways, for example, the email environment may consist of any email system, which also includes, but is not limited to, any closed email system environment which has digital signature capabilities and secure identification of all email senders and recipients. Specific details regarding one particular closed email system environment can be found in IBM Software Messaging and Collaboration Solution Brief titled “Smarter collaboration solutions from IBM”, incorporated herein by reference.

In a preferred embodiment, a sender is able to write an email and select an urgent (which may also be referred to as extraordinary, hyper-urgent, important, etc.) tag to designate that the email is more important than a regular email. This tagged urgent email is sent to a receiving email client, where it is determined whether this email is to be treated as an urgent email, or if it is to be treated as a normal email. If the email is treated as an urgent email, the person using the receiving email client, also referred to as the receiving user, may rate the received urgent email, which determines if future urgent emails sent from the sender will be seen as urgent or not in receiver's email client for a set period of time. “Urgent email” and “urgent tagged email” may be used interchangeably in this application.

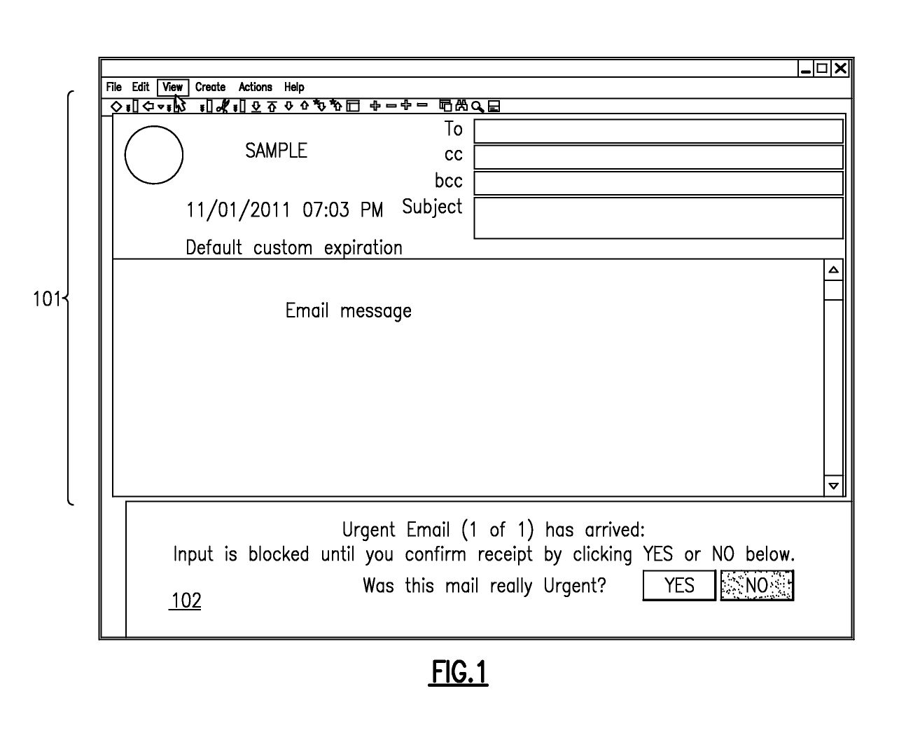

One embodiment of a user interface of the receiving email client in accordance with one or more aspects of the present invention is illustrated in FIG. 1. As shown in FIG. 1, an urgent email has been received at the receiving email client and is displayed, 101. A prompt may appear on screen, 102, which may describe the number of urgent emails received, a message prompting the user to confirm receipt of the email, or a message prompting the user to determine if the email was actually urgent.

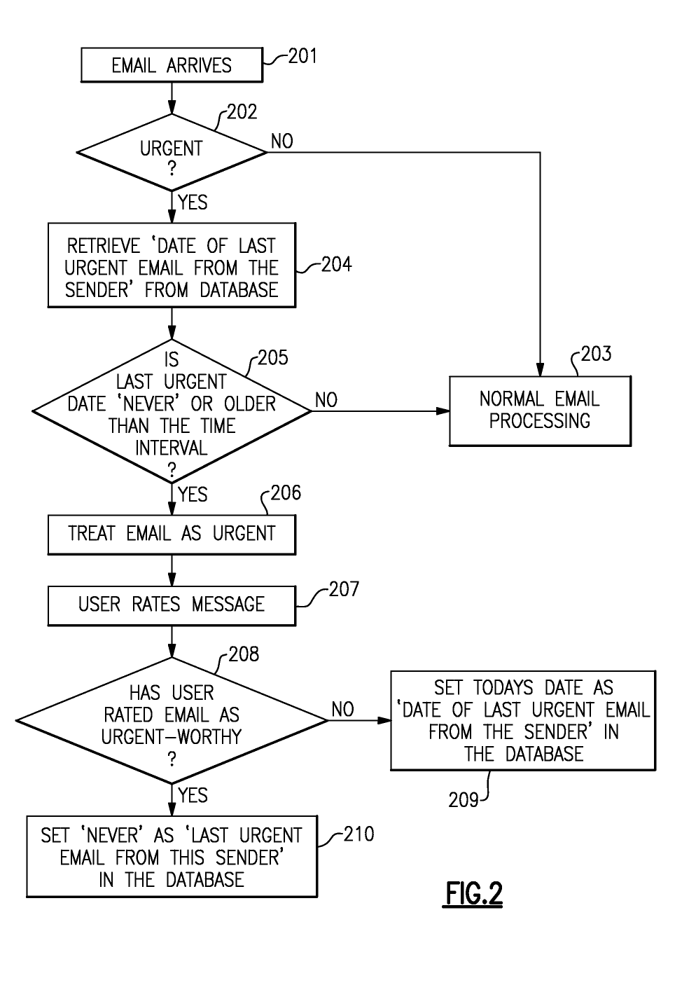

One embodiment of a flow diagram for receiving an urgent tagged email in accordance to the present invention is described in reference to FIG. 2. The email arrives at a receiving email client, 201. The receiving email client checks to see if the received email is tagged as urgent, 202. If the received email is not tagged as urgent, the email is processed as a normal email, 203. Normal email processing is well known in the art and beyond the scope of the present invention. If the received email is tagged as urgent, the receiving email client retrieves from a database the “date of the last urgent email” sent from the sender, 204. The database may be a local database or a non-local database. The “date of the last urgent email” may include a specific date. In one embodiment, the “date of the last urgent email” may include an allowed value, such as “never”. The allowed value tells the receiving email client that this received urgent email should be allowed to proceed as an urgent email. In one embodiment, if the sender has not previously sent an urgent tagged email, the “date of the last urgent email” is set to the allowed value.

Once the “date of the last urgent email” is received, it is checked to see if the received urgent email is allowed to proceed as an urgent email. In one embodiment, the “date of the last urgent email” may be checked to see if it has an allowed value, for example “never”, or if it is outside of a predefined time interval, 205. The predefined time may be a set time period, for example one week, two weeks, a month, a year, etc. This predefined time may be defined by the receiving user or may be automatically determined by the receiving email client. If the “date of the last urgent email” is not the allowed value and is within the predefined interval, then normal email processing is performed, 203.

If the “date of the last urgent email” is either the allowed value (ex: “never”) or is outside the predefined interval, then received urgent email is treated as an urgent email, 206, and sent for display in the receiving user's email client as such. In one embodiment, the urgent email is displayed to the receiving user through a variety of ways. For example, the receiving user may be forced to open the urgent tagged email by the receiving email client. The urgent tagged email may be visually highlighted in the receiving email client. The urgent tagged email may bypass spam filtering. The receiving email client may disable the ability to delete the urgent tagged email until the urgent tagged email is read by the receiving user. The receiving email client may force the receiving user to acknowledge that the receiving user read the urgent tagged email before it is dismissed from the screen. There may be a full screen takeover of the computer until the content of the urgent tagged email is read by the receiving user. There may also be a combination of the above, or any other method of displaying the urgent tagged email.

Once the user reads the urgent email, he or she has the option to rate the email message, 207. The receiving user determines if the received urgent email as being worthy or unworthy of being an urgent tagged email, 208. If the urgent email is deemed unworthy, the “date of the last urgent email” in the database may be set to the date of receipt of the received urgent email, 209. This would have the effect of extending the period in which a future received urgent email is treated as a regular email. If the urgent email is deemed worthy, the “date of the last urgent email” in the database may be set to an allowed value, such as “never”. This would have the effect of allowing a future received urgent email go through the receiving email client as an urgent email.

In one embodiment, before step 204, the receiving email client may check to see if the sender is on a whitelist. This may be used as a first filter to determine which received urgent tagged emails are treated as such in the receiving email client. The whitelist may contain a list of senders that the receiving user has previously selected as senders who are allowed to send urgent email messages to the user. The white list may be stored in a local or nonlocal database. If the receiving email client determines that the sender is not on the whitelist, then the received urgent email is treated as a normal email, 203. If the receiving email client determines that the sender is on the whitelist, the process proceeds to 204.

In one embodiment, after step 208, if the receiving user rates the urgent email as not worthy of being an urgent tagged email, a notification may be sent to the sender. This notification may be in the form of an email. This notification may state that the receiving user has received the urgent tagged email, evaluated it, and has determined it not to be worthy of being urgent tagged.

In one embodiment, the sender writes the urgent email on a sender email client on sender's computer. The sender may select an urgent tag for the urgent email. Once the urgent email has been written and tagged, the sender may send this email to the receiving user, where the process described above in reference to FIG. 2 proceeds.

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, the embodiments of present invention may be embodied as a system, method or computer program product. Accordingly, the embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiment of present invention may take the form of a computer program product embodied in any tangible medium of expression having computer usable program code embodied in the medium.

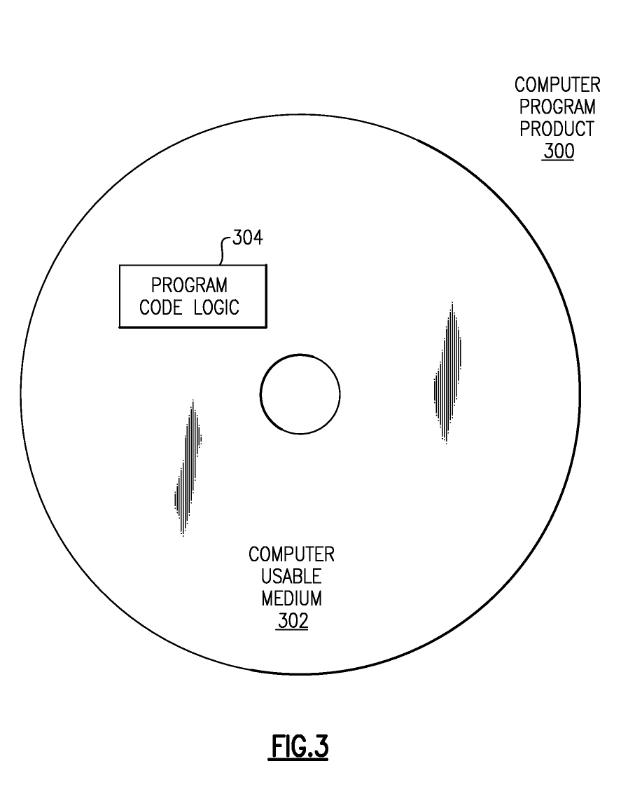

One example of a computer program product incorporating one or more aspects of an embodiment of the present invention is described with reference to FIG. 3. A computer program product 300 includes, for instance, one or more computer usable media 302 to store computer readable program code means or logic 304 thereon to provide and facilitate one or more aspects of an embodiment of the present invention. Any combination of one or more computer usable or computer readable medium(s) may be utilized. The computer-usable or computer-readable medium may be, for example but not limited to, an electronic, magnetic, optical, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device. In the context of this document, a computer-usable or computer-readable medium may be any storage medium that can contain or store the program for use by or in connection with the instruction execution system, apparatus, or device.

Computer program code for carrying out operations of the embodiment of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

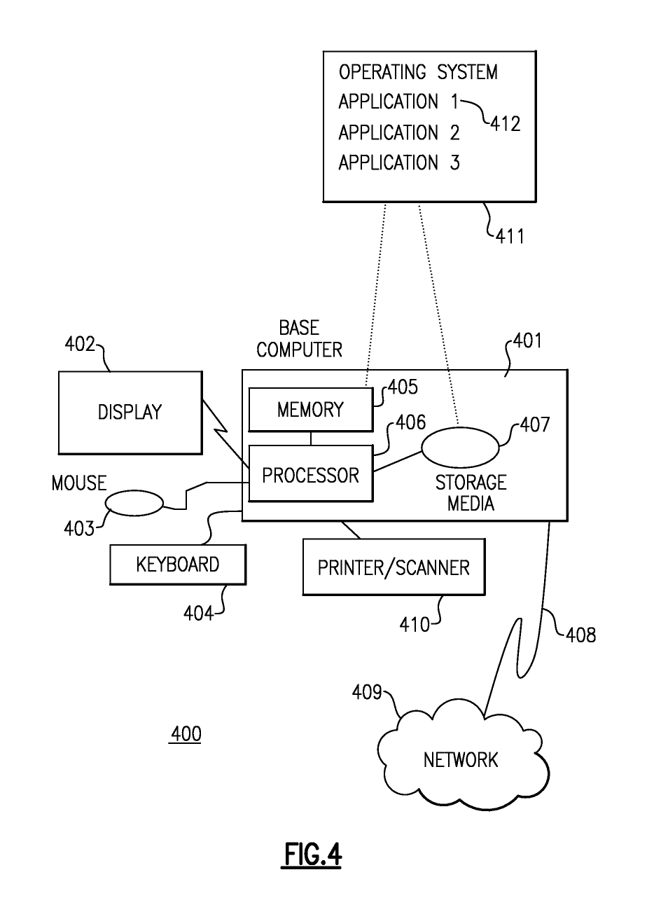

FIG. 4 illustrates an embodiment of a computer system in which an embodiment of the present invention may be practiced. The system comprises a computer system 401, such as a mobile device, a personal computer, a workstation, a server, a storage device, or host, including optional peripheral devices. The computer system 401 includes one or more processors 406 and a bus employed to connect and enable communication between the processor(s) 406 and the other components of the computer system 401 in accordance with known techniques. The bus connects the processor 406 to memory 405 and long-term storage 407 which can include a hard drive (including any of magnetic media, CD, DVD and Flash Memory for example) or a tape drive for example. The computer system 401 might also include a user interface adapter, which connects the microprocessor 406 via the bus to one or more interface devices, such as a keyboard 504, mouse 403, a printer/scanner 410 and/or other interface devices, which can be any user interface device, such as a touch sensitive screen, digitized entry pad, etc. The bus also connects a display device 402, such as an LCD screen or monitor, to the microprocessor 406 via a display adapter.

The computer system 401 may communicate with other computers or networks of computers by way of a network adapter capable of communicating 408 with a network 409. For example, network adapters may include communications channels, token ring, Ethernet or modems. Alternatively, the computer system 401 may communicate using a wireless interface, such as a CDPD (cellular digital packet data) card. The computer system 401 may be associated with such other computers in a Local Area Network (LAN), VLAN, or a Wide Area Network (WAN), or the computer system 401 may be a client in a client/server arrangement with another computer, etc. All of these configurations, as well as the appropriate communications hardware and software, are known in the art.

Software programming code which embodies the present invention may be typically accessed by the processor 406 from long-term storage media 407. The software programming code may be embodied on any of a variety of known media for use with a data processing system, as previously described above with reference to FIG. 3. The code may be distributed on such media, or may be distributed to users from the memory or storage of one computer system over a network to other computer systems.

Alternatively, the programming code 411 may be embodied in the memory 405, and accessed by the processor 406 using the processor bus. Such programming code may include an operating system which controls the function and interaction of the various computer components and one or more application programs 412. Program code may be normally paged from storage media 407 to memory 405 where it may be available for processing by the processor 406. The techniques and methods for embodying software programming code in memory, on physical media, and/or distributing software code via networks are well known and will not be further discussed herein. The computer program product medium may be typically readable by a processing circuit preferably in a computer system for execution by the processing circuit.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow.

What is claimed is:

1. A method for receiving an urgent email message by a sender, the method comprising:
receiving, by an email client on a computer, an urgent tagged email sent by said sender;
obtaining an urgent timestamp based on a stored timestamp of a previous urgent tagged email by said sender;
based on said urgent timestamp, determining whether said urgent tagged email is allowed, said allowed determining comprising determining whether said urgent tagged email was received within a defined time interval and determining whether said previous timestamp is an allowed value; and
responsive to said urgent tagged email being allowed, performing a, b, c, and d:
a) displaying said urgent tagged email in said email client with an urgent response;
b) evaluating, by a user, whether said urgent tagged email was worth being tagged as urgent;
c) responsive to said evaluating that said urgent tagged email was not worth being tagged as urgent, updating said stored timestamp to a date of said urgent tagged email; and
d) responsive to said evaluating that said urgent tagged email was worth being tagged as urgent, updating said stored timestamp to said allowed value.

2. The method according to claim 1, wherein obtaining an urgent timestamp further comprises determining whether said sender sent a previous extraordinary tagged email to said email client.

3. The method according to claim 2, wherein responsive to said determination that said sender did not send a previous extraordinary tagged email, said obtained timestamp is defined to be said allowed value.

4. The method according to claim 1, further comprising responsive to said urgent tagged email being allowed and responsive to said evaluating that said urgent tagged email was not worth being tagged as urgent, notifying said sender that said user has evaluated said urgent tagged email as not worth being tagged as urgent.

5. The method according to claim 1, further comprising responsive to said urgent tagged email not being allowed, displaying said urgent tagged email as a regular untagged email in said email client.

6. The method according to claim 1, wherein said urgent response comprises forced opening of said urgent tagged email by said email client, bypassing of spam filtering by said email client, disabling an ability to delete said urgent tagged email until said urgent tagged email is read, full screen takeover of said computer until content of said urgent tagged email is read by user, full screen takeover of the email client until content of the urgent tagged email is read by the user, or a combination thereof.

7. The method according to claim 1, further comprising:
verifying said sender against a whitelist, said whitelist created by said user to designate one or more specific senders who are permitted to send urgent tagged emails to said email client;
wherein obtaining said urgent timestamp is performed in response to said verifying that said sender is in said whitelist;
responsive to said verifying that said sender is not in said whitelist, displaying said urgent tagged email as a regular untagged email in said email client; and
wherein said determining whether said urgent tagged email is allowed is based on said verifying that said sender is in said whitelist.

8. The method according to claim 1, further comprising:
writing, by said sender on sender's email client on sender's computer, said urgent tagged email;
selecting, by said sender on sender's email client, an urgent tag for said urgent tagged email; and
sending, by said sender, said urgent tagged email.

9. The method according to claim 1, wherein said email client supports receiving signed messages

10. The method according to claim 1, wherein said predetermined time value is selected by the user.

11. A system for receiving an urgent email message by a sender comprising:
a memory;
a processor in communications with said memory, said processor capable of performing a method comprising:
receiving, by an email client on said system, an urgent tagged email sent by said sender;
obtaining an urgent timestamp based on a stored timestamp of a previous urgent tagged email by said sender;
based on said urgent timestamp, determining whether said urgent tagged email is allowed, said allowed determining comprising determining whether said urgent tagged email was received within a defined time interval and determining whether said previous timestamp is an allowed value; and
responsive to said urgent tagged email being allowed, performing a, b, c, and d:
a) displaying said urgent tagged email in said email client with an urgent response;
b) evaluating, by a user, whether said urgent tagged email was worth being tagged as urgent;
c) responsive to said evaluating that said urgent tagged email was not worth being tagged as urgent, updating said stored timestamp to a date of said urgent tagged email; and
d) responsive to said evaluating that said urgent tagged email was worth being tagged as urgent, updating said stored timestamp to said allowed value.

12. The system according to claim 11, wherein obtaining an urgent timestamp further comprises determining whether said sender sent a previous extraordinary tagged email to said email client.

13. The system according to claim 2, wherein responsive to said determination that said sender did not send a previous extraordinary tagged email, said obtained timestamp is defined to be said allowed value.

14. The system according to claim 11, further comprising responsive to said urgent tagged email being allowed and responsive to said evaluating that said urgent tagged email was not worth being tagged as urgent, notifying said sender that said user has evaluated said urgent tagged email as not worth being tagged as urgent.

15. The system according to claim 11, further comprising responsive to said urgent tagged email not being allowed, displaying said urgent tagged email as a regular untagged email in said email client.

16. The system according to claim 11, wherein said urgent response comprises forced opening of said urgent tagged email by said email client, bypassing of spam filtering by said email client, disabling an ability to delete said urgent tagged email until said urgent tagged email is read, full screen takeover of said computer until content of said urgent tagged email is read by user, full screen takeover of the email client until content of the urgent tagged email is read by the user, or a combination thereof.

17. The system according to claim 11, further comprising:
verifying said sender against a whitelist, said whitelist created by said user to designate one or more specific senders who are permitted to send urgent tagged emails to said email client;
wherein obtaining said urgent timestamp is performed in response to said verifying that said sender is in said whitelist;
responsive to said verifying that said sender is not in said whitelist, displaying said urgent tagged email as a regular untagged email in said email client; and
wherein said determining whether said urgent tagged email is allowed is based on said verifying that said sender is in said whitelist.

18. The system according to claim 11, further comprising:
writing, by said sender on sender's email client on sender's computer, said urgent tagged email;
selecting, by said sender on sender's email client, an urgent tag for said urgent tagged email; and
sending, by said sender, said urgent tagged email.

19. The method according to claim 11, wherein said predetermined time value is selected by the user.

20. A computer program product for receiving an urgent email message by a sender, the computer program product comprising:
a storage medium readable by a processing circuit and storing instructions for execution by the processing circuit for performing a method comprising:
receiving, by an email client on a computer, an urgent tagged email sent by said sender;
obtaining an urgent timestamp based on a stored timestamp of a previous urgent tagged email by said sender;
based on said urgent timestamp, determining whether said urgent tagged email is allowed, said allowed determining comprising determining whether said urgent tagged email was received within a defined time interval and determining whether said previous timestamp is an allowed value; and
responsive to said urgent tagged email being allowed, performing a, b, c, and d:
a) displaying said urgent tagged email in said email client with an urgent response;
b) evaluating, by a user, whether said urgent tagged email was worth being tagged as urgent;
c) responsive to said evaluating that said urgent tagged email was not worth being tagged as urgent, updating said stored timestamp to a date of said urgent tagged email; and
d) responsive to said evaluating that said urgent tagged email was worth being tagged as urgent, updating said stored timestamp to said allowed value.
